(19) United States
(12) Patent Application Publication
(10) Pub. No.: US 2004/0126312 A1
(43) Pub. Date: Jul. 1, 2004

(54) Method of producing organic hydrogen peroxide solutions

(76) Inventors: Thomas Butz, Ludwigshafen (DE); Martin Fischer, Ludwigshafen (DE); Klemens Massonne, Bad Durkheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/474,686

(22) PCT Filed: Apr. 11, 2002
(86) PCT No.: PCT/EP02/04052

(30) Foreign Application Priority Data
Apr. 12, 2001 (DE) 10118460.3

(51) Int. Cl. C01B 15/01

(52) U.S. Cl. 423/584

(57) ABSTRACT

In a continuous process for preparing hydrogen peroxide solution in a medium comprising a water-miscible organic solvent by reaction of hydrogen and oxygen in the presence of an inert gas, the gas stream is circulated and fresh hydrogen and oxygen are introduced in the form of pure gases only at a rate corresponding to that at which they are consumed. The solution prepared in this way can be used for the epoxidation of olefins.

The present invention relates to a continuous process for preparing a solution of hydrogen peroxide in a medium comprising a water-miscible organic solvent by reaction of hydrogen and oxygen and also to the use of the solution prepared in this way for the epoxidation of olefins.

The direct synthesis of hydrogen peroxide from the elements has been the subject matter of comprehensive studies. The major part of the hydrogen peroxide produced industrially is produced in the form of an aqueous solution. However, it is sometimes advantageous to have a solution of hydrogen peroxide in an organic medium, e.g. when the hydrogen peroxide solution is to be used for the epoxidation of olefins, since the epoxidation is usually carried out in an organic reaction medium.

WO 00/35894 describes the synthesis of hydrogen peroxide from hydrogen and oxygen over a palladium-containing catalyst using methanol as solvent. The methanolic hydrogen peroxide solution formed is subsequently used for the epoxidation of propylene.

Apart from the known danger of explosion of gas mixtures comprising oxygen and more than 4% by volume of hydrogen, the use of an organic solvent as reaction medium involves a further risk of explosion of the organic solvent in contact with oxygen. This is the case even when the amount of combustible materials in the gas phase is not alone capable of explosion under the reaction conditions, i.e. when the sum of the proportion of hydrogen and the proportion of solvent vapor is less than the lower explosive limit. U.S. Pat. No. 4,889,705 therefore teaches the use of an aqueous reaction medium which contains not more than 2% of combustible, organic constituents.

Measurements have shown that methanol/oxygen mixtures at, for example, a pressure of 50 bar, i.e. in the customary pressure range of the hydrogen peroxide synthesis, can be caused to explode by a source of ignition. Accidental ignition can, for example, result from a hydrogen-saturated palladium catalyst becoming red hot in the presence of oxygen. The risk of explosion cannot be eliminated by dilution of the organic solvent with water.

An inherent risk of explosion is not tolerable in an industrial process. It would be necessary to use expensive, explosion-resistant apparatuses and to undertake further costly safety measures which would in the final analysis make the process uneconomical.

EP 0 978 316 discloses a process for preparing hydrogen peroxide from the elements using a specific catalyst on an activated carbon support which has been functionalized with sulfonic acid groups. An example illustrates the batchwise preparation of a methanolic hydrogen peroxide solution from a gas mixture comprising 4% by volume of hydrogen, 4% by volume of oxygen and 92% by volume of nitrogen. In a further example in EP 0 978 316, a continuous process carried out in a single pass using a gas mixture comprising 3.6% of hydrogen, 36.4% of oxygen and 60% of nitrogen is described. The technical effect of the concomitant use of nitrogen is not discussed.

In an industrial process, it is desirable to carry the reaction out continuously so as to be able to work at a constant pressure.

If the concomitant use of an inert gas is intended, air is frequently used as oxygen source in industrial processes since air contains about 78% by volume of nitrogen. To make optimal use of the hydrogen and oxygen introduced, it is desirable to collect the unreacted reaction gases and to return them together with fresh inert gas-containing gas to the reaction zone. However, since the inert gas is not consumed, this procedure results in accumulation of the inert gas in the reaction gas. To prevent the inert gas concentration in the reaction gas from rising continuously and reaching values at which the hydrogen peroxide synthesis stops, inert gas has to be removed via a waste gas stream, i.e. by recirculating only part of the unreacted reaction gases and removing the residual stream from the process. However, unreacted reaction gases are also unavoidably removed in the waste gas stream. This stripping effect is, in particular, disadvantageous in respect of the hydrogen consumption because the provision of hydrogen gas is technically complicated.

DE 196 42 770 discloses a process for preparing hydrogen peroxide solutions by continuous reaction of hydrogen and oxygen in water and/or C₁-C₃-alkanols. It is stated that the reaction gas can be circulated.

It is an object of the present invention to provide a process for the synthesis of hydrogen peroxide in a water-miscible organic medium from the elements hydrogen and oxygen in the presence of an amount of inert gas sufficient to eliminate the risk of fire and explosion resulting from organic solvents in contact with oxygen gas, which process makes optimal use of the hydrogen gas introduced.

We have found that this object is achieved by a process for the continuous preparation of a solution of hydrogen peroxide in a medium comprising a water-miscible organic solvent, in which

a) a catalyst comprising a noble metal is installed in a reaction zone;

b) a liquid stream comprising a water-miscible organic solvent is passed through the reaction zone;

c) a gas stream comprising hydrogen, oxygen and an inert gas, where the volume ratio of inert gas to oxygen is at least 2.5:1, is simultaneously passed through the reaction zone;

d) after passage through the reaction zone, the gas stream which has been depleted in hydrogen and oxygen is taken off and recirculated to the reaction zone;

e) the gas stream is admixed with essentially pure hydrogen and essentially pure oxygen; and

f) the hydrogen peroxide solution formed is taken off as a liquid stream.

Although the organic solvent used is explosive in an oxygen-rich atmosphere, the advantage of the process of the present invention is the safe preparation of a hydrogen peroxide solution in the organic solvent. The hydrogen peroxide solutions obtained can advantageously be used directly, without being concentrated and/or being subjected to costly purification, for the epoxidation of olefins.

For the purposes of the present invention, a “water-miscible organic solvent” is an organic solvent which dissolves at least 10% by weight of water or is soluble in water to an extent of at least 40% by weight. The organic solvent can be used in combination with up to 50% by weight of water, e.g. with from 1 to 20% by weight of water. The liquid stream preferably comprises from 50 to 100% by weight of the organic solvent, in particular from 80 to 100% by weight. Technical-grade solvents having a purity of more than 85% by weight, in particular more than 90% by weight, are suitable.

These include alcohols having from 1 to 4 carbon atoms, preferably methanol, ethanol, n-propanol or isopropanol, ketones having from 3 to 5 carbon atoms, preferably acetone, butanone or methyl isopropyl ketone, alkanediols having from 2 to 4 carbon atoms, preferably ethylene glycol or propylene glycol, dialkyl ethers having a total of from 2 to 6 carbon atoms, e.g. diisopropyl ether, alkanediol monoalkyl ethers having a total of from 3 to 8 carbon atoms, preferably methyl glycol, ethyl glycol, butyl glycol, propylene glycol monomethyl ether or propylene glycol monomethyl ether, alkanediol dialkyl ethers having a total of from 4 to 10 carbon atoms, preferably ethylene glycol diethyl ether, and cyclic ethers having from 4 to 6 carbon atoms and from 1 to 2 ring oxygens, preferably tetrahydrofuran or dioxane. The preferred organic solvents are methanol and acetone, with methanol being particularly preferred.

Suitable catalysts are all noble metal catalysts which are known to those skilled in the art and catalyze the reaction of hydrogen and oxygen to form hydrogen peroxide, preferably ones whose active component comprises at least one metal of the platinum group, in particular palladium. If desired, they may further comprise other metals such as rhodium, iridium, ruthenium, gold, copper, cobalt, tungsten, molybdenum, tin, rhenium and/or nonmetals such as phosphorus or boron.

The catalysts can have been applied to metallic or nonmetallic, porous or nonporous supports, with the deposition of the noble metal on the support preferably being carried out by an electroless method, for example by impregnating or wetting the support with a solution comprising the noble metal salt and a reducing agent.

The supports can be in appropriate forms such as metal sheets, wires, meshes, gauzes, woven fabrics or shaped bodies such as Raschig rings, saddles, wire spirals, wire mesh rings or else monoliths, as are described in DE-A 196 42 770.

Metalic supports are preferably made of high alloy stainless steels. Among nonmetallic supports, preference is given to nonporous supports, in particular mineral materials, plastics or a combination of the two. Suitable mineral materials are natural and synthetic minerals, glasses or ceramics. Suitable plastics are natural or synthetic polymers.

Suitable reaction zones are pressure-rated reactors, preferably tubular reactors and particularly preferably shell-and-tube reactors. The temperature in the reaction zone can be regulated by means of an external cooling circuit and/or an internal cooling system.

The catalyst is preferably installed in the form of one or more catalyst beds. The beds advantageously rest on appropriate holders, e.g. perforated metal plates. The reaction can be carried out either in the upflow mode or in the downflow mode. In the case of operation in the upflow mode, the gas stream and the liquid stream are passed through the catalyst bed from the bottom upward, with the liquid stream generally forming a coherent phase and the gas being present in the form of discrete gas bubbles. In the downflow mode, the gas stream and the liquid stream are passed through the catalyst bed in cocurrent from the top downward, with the gas phase generally being the coherent phase and the liquid phase flowing through in a pulsating manner or in the form of small streams or as laminar flow.

As an alternative, the catalyst can be present as a suspended catalyst. This can, for example, be separated from the liquid output from the reaction zone by filtration or decantation.

For the purposes of the present invention, inert gases are gases which do not undergo an undesirable interaction with any of the components, i.e. hydrogen, oxygen, the organic medium, catalyst or the hydrogen peroxide solution, under the conditions of the hydrogen peroxide synthesis. Such gases include nitrogen, carbon dioxide and the noble gases such as helium, neon, argon or mixtures thereof. Preference is given to nitrogen.

The inert gas is present in the gas stream passed through the reaction zone in such an amount that the volume ratio of the inert gas to oxygen at any point in the reaction zone is at least 2.5:1, preferably at least 3.5:1. The presence of the inert gas prevents an explosive reaction of the organic solvent with oxygen even in the event of accidental ignition. The amount of inert gas required in a particular case may be dependent on the organic solvent used, on the pressure and on the temperature and can if necessary be determined by means of appropriate ignition tests.

The proportion of hydrogen in the gas phase is preferably not more than 4% by volume at any point in the reaction zone. The molar ratio of oxygen to hydrogen is preferably at least 2:1, e.g. from 2:1 to 100:1 and particularly preferably at least 4:1.

Molar ratios of at least 2:1 lead to higher selectivities in respect of hydrogen peroxide formation.

The total pressure of the gas stream is generally from 1 to 300 bar, preferably from 10 to 200 bar and particularly preferably from 30 to 150 bar. The reaction temperature is generally from 0 to 80° C., preferably from 5 to 60° C. and particularly preferably from 25 to 55° C.

In the reaction zone, hydrogen and oxygen are consumed in a reaction over the catalyst comprising a noble metal to form hydrogen peroxide which dissolves in the liquid stream and is carried with this from the reaction zone. After passage through the reaction zone, the gas stream is depleted in hydrogen and oxygen. According to the present invention, all of the depleted gas stream is recirculated to the reaction zone. Gas pumps or compressors, e.g. centrifugal compressors, are suitable for this. To keep the gas stream free of entrained droplets, it may be advantageous to convey the gas stream and the liquid stream from the reaction zone into a phase separation vessel through which the streams flow at a low flow velocity and from which the gas stream can be taken off. The gas stream may be cooled if appropriate to remove part of the heat of reaction. If desired, the liquid stream which has been taken off can also be passed through the reaction zone a plurality of times to obtain higher hydrogen peroxide concentrations than would be given by a single pass.

The amount of hydrogen and oxygen consumed is replaced by admixing the gas stream with essentially pure oxygen and essentially pure hydrogen. It is a critical feature of the invention that essentially pure gases are used as sources of hydrogen and oxygen, respectively, so that no appreciable amounts of inert gases are introduced into the gas stream via the fresh hydrogen and oxygen. For the purposes of the present invention, “essentially pure” indicates that industrial gases which may contain minor amounts of extraneous gases can also be used. The fresh hydrogen and oxygen gases introduced generally have a purity of at least 97% by volume, in particular at least 99% by volume, particularly preferably at least 99.5% by volume. The addition can be made to the recirculated gas stream or at one or more points in the reaction zone.

As a result, an essentially constant amount of inert gas (“inert gas buffer”) which does not participate in the reaction and is merely circulated is present in the reaction zone and in the gas recycle circuit. Supplementary amounts of inert gas are necessary only as a result of unavoidable losses, e.g. caused by the physical solubility in the liquid stream or the taking of samples for analysis.

In a preferred embodiment of the process of the present invention, addition of fresh hydrogen and oxygen and, if necessary, inert gas is controlled as a function of consumption. For this purpose, the composition of the gas stream and/or the depleted gas stream is determined continuously or periodically by analysis, the composition is compared with a prescribed composition and further hydrogen, oxygen and/or inert gas are/is added in the amount indicated by this comparison. To determine the composition of the gas stream, a small amount of gas is taken off continuously or periodically and analyzed by means of gas analysis. Various methods are available for the gas analysis, e.g. gas chromatography, thermal conductivity measurement, gas density measurement, mass spectroscopy, measurement of the speed of sound and magnetomechanical measurement methods. The gas sample taken for analysis can be taken off at any point of the gas recycle circuit, for example after the depleted gas stream leaves the reaction zone or before the gas stream admixed with fresh gases reenters the reaction zone.

To stabilize the hydrogen peroxide against decomposition, acids whose pKₐ is, preferably, less than that of acetic acid, in particular mineral acids such as sulfuric acid, phosphoric acid, hydrobromic acid or hydrochloric acid, are generally added to the reaction medium. The acid concentration is generally at least 10⁻⁴ mol/l, preferably from 10⁻³ to 10⁻² mol/l.

Furthermore, the liquid stream fed into the reaction zone generally also contains small amounts of halides, e.g. bromide or chloride, or pseudohalides in concentrations of, for example, from 1 to 1000 ppm, preferably from 3 to 300 ppm. Particular preference is given to using hydrobromic acids which combines the functions of acid and halide, usually in concentrations of from 1 to 2000 ppm, preferably from 10 to 500 ppm.

The solution of hydrogen peroxide in an organic solvent which has been prepared by the process of the present invention and may contain water can be used without isolation of the hydrogen peroxide for the epoxidation of olefins, in particular propylene but also ethylene, cyclohexene, cyclooctene, 2-butene, 1-octene, allyl chloride, isoprene, etc. If appropriate, the solutions can be neutralized by addition of bases or by means of ion exchangers prior to the epoxidation step.

The epoxidation of olefins by means of the hydrogen peroxide solution prepared according to the present invention is carried out over suitable catalysts, e.g. titanium silicalite catalysts as are described in EP-A-100 119. Here, epoxidized olefins are obtained from olefins and dilute, alcoholic or aqueous-alcoholic hydrogen peroxide solutions in the presence of a synthetic titanium-containing zeolite of the formula xTiO₂*(1-x)SiO₂, where x is in the range from 0.0001 to 0.04. This process can advantageously be improved by means of the specific embodiments of EP-A-200 260, EP-A-230 949 and DE-A-196 23 611.

The hydrogen peroxide solution which has been depleted in the epoxidation step can advantageously be returned to the hydrogen peroxide synthesis of the present invention, with any stabilizers removed prior to the epoxidation step being replaced.

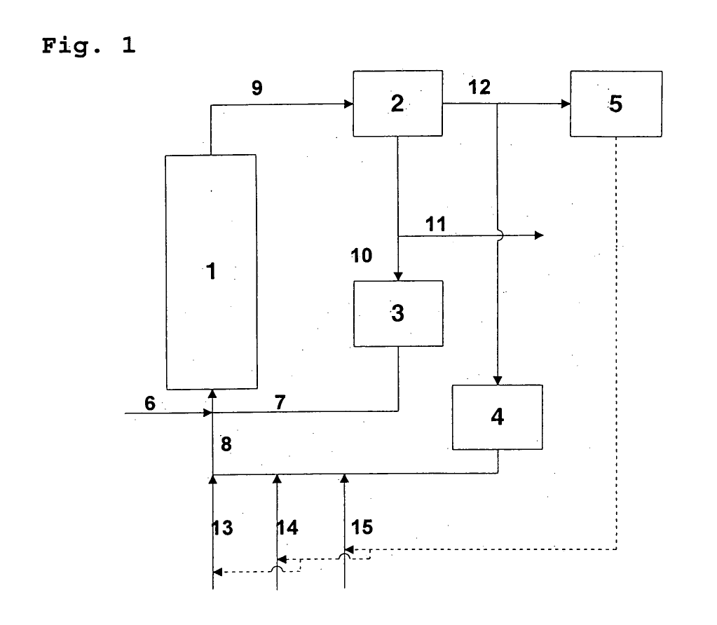

The invention is illustrated by the accompanying FIG. 1 and the examples below.

FIG. 1 schematically shows a plant suitable for carrying out the process of the present invention. A liquid stream comprising a water-miscible organic solvent is fed via line 6 into the pressure reactor 1 which is, for example, a cooled double-walled tube. At the same time, a gas stream comprising hydrogen, oxygen and an inert gas is fed via line 8 into the pressure reactor 1. The two-phase, gaseous/liquid mixture leaving the pressure reactor 1 goes via line 9 to a separator 2. Part of the liquid fraction obtained there is discharged as H₂O₂ solution via line 11 and part of it is recirculated via line 10, the liquid pump 3 and line 7 to the pressure reactor 1. The gaseous fraction obtained in the separator 2 is conveyed via line 12, the diaphragm compressor 4 and line 8 back to the pressure reactor 1. The composition of the gas stream obtained from the separator 2 is continuously analyzed by means of the gas analysis apparatus 5. The gas analysis apparatus 5 provides an electronic measurement signal which controls the introduction of hydrogen gas, oxygen gas and inert gas via lines 13, 14 and 15.

### EXAMPLES

### Catalyst Production

Catalyst A:

The supports used were rolls of mesh made by rolling up two layers of wire braid having dimensions of 3×17 mm to form cylinders having a diameter of 3 mm and a height of 3 mm. The wire braid was made of 100 μm thick wires made of the steel 1.4539. The supports were degreased by means of an aqueous surfactant solution in an ultrasonic bath at 40° C. for 90 minutes and were pickled with 10% strength hydrochloric acid at 60° C. for 60 minutes in a circulation apparatus.

770 ml of the pretreated mesh rolls were placed in a coating reactor comprising a glass tube having a diameter of 50 mm and provided with a heating jacket and liquid circulation facility.

A mixture comprising 1600 ml of water, 96 g of sodium hypophosphite, 216 g of ammonium chloride and 320 ml of 25% strength ammonia was placed in the coating reactor and the contents of the reactor were heated to 60° C. while circulating the liquid (400 l/h).

120.6 g of a 1% strength solution of sodium tetrachloropalladate (1% by weight of palladium) were mixed with 1.65 g of a 0.1% strength solution of hexachloroplatinate acid (0.1% by weight) and this solution was likewise introduced into the coating reactor.

The circulated solution briefly became brown and became colorless again after a few minutes. The liberation of very fine gas bubbles and at the same time a change in color of the support from gray to dark gray or black were observed.

After about one hour, evolution of gas dropped substantially. The solution was dried and the rolls of mesh were rinsed with water.

Analysis of the solution showed that the noble metals had been deposited virtually quantitatively on the support.

Catalyst B:

800 ml of steatite spheres (from Ceramtec) having a diameter of 1.8-2.2 mm were placed on a G4 suction filter. A solution of 5 g of tin(II) chloride and 10 ml of concentrated hydrochloric acid in 1 l of water was prepared and 500 ml of this solution was allowed to seep through the spheres over a period of 3 minutes. The spheres on the filter were then washed with 0.5 l of water. A solution of 167 mg of palladium chloride and 0.5 ml of concentrated hydrochloric acid in 0.5 l of water was subsequently allowed to seep through the layer of steatite spheres, again over a period of 3 minutes, and the spheres were once again washed with water.

The entire procedure was repeated one more time.

The activated spheres were placed in the above-described coating reactor. After addition of a solution of 85.2 g of sodium hypophosphite, 192.2 g of ammonium chloride and 259 ml of 25% strength ammonia in 2.6 l of water, the contents of the reactor were heated to 40° C. while circulating the liquid by pumping. A solution of 529 mg of sodium tetrachloride palladate and 11 mg of hexachloroplatinic acid in 20 ml of water was subsequently added and circulation of the mixture was continued. After 90 minutes, the liquid was drained, the catalyst was washed with water until free of salts and dried at 50° C. under reduced pressure.

Analysis of the solution showed that more than 90% of the metals introduced had been deposited.

### Example 1

An apparatus as shown in FIG. 1 was used. 700 ml of catalyst were introduced into the reactor 1 configured as a double-walled metal tube (diameter: 21 mm, length: 2.00 m). To regulate the temperature, a cooling circuit was connected to the jacket of the reactor. A temperature of 40° C. was set for the time of the experiment.

The feed consisted of a solution of 121 ppm of hydrogen bromide in methanol. The solution was pumped through the plant at a constant rate of 1000 ml/h. At the same time, the liquid was circulated at a circulation rate of 150 l/h. The plant was brought to a pressure of 50 bar by feeding in nitrogen through a pressure regulating valve. The diaphragm compressor 4 was switched on and set to a gas circulation of 10400 standard l/h. A gas stream of 44 standard l/h was taken off and fed into the gas analysis apparatus 5 which comprised a thermal conductivity detector and an oxygen analyzer and allowed the hydrogen and oxygen contents of the gas mixture to be determined continuously. The metering valve for oxygen was controlled so that the gas stream contained 19% of oxygen after passing through the reaction zone. The metering valve for hydrogen was subsequently controlled so that the gas stream contained 3% of hydrogen after passing through the reaction zone. These two streams together with the mass throughput meter for nitrogen were continually regulated so that the gas stream after passing through the reaction zone and thus also the circulated gas contained 3% of hydrogen and 19% of oxygen. The liquid leaving the reaction tube was separated from the circulating gas in the separator 2 and discharged from the plant. The hydrogen peroxide content in the liquid output was monitored continually by means of titration.

The pressure reaction was operated continuously for 72 hours. After 17 hours, the hydrogen conversion and the hydrogen peroxide content of the liquid output was constant. Contents of 7% by weight of hydrogen peroxide and 1.4% by weight of water were measured in the output. The selectivity can be calculated as 72% from the amount of hydrogen consumed. The space-time yield was 109 g/l*h, based on the catalyst volume.

### Example 2

An apparatus as shown in FIG. 1 was used, but the gas stream to the gas analysis apparatus 5 was taken off directly upstream of the reactor inlet. The double-walled reactor 1 of the apparatus was charged with catalyst B. At 40° C. and a pressure of 50 bar, a solution of 120 mg/l of hydrogen bromide in methanol was allowed to trickle over the catalyst bed at a rate of 1000 ml/h. At the same time, a mixture of 3.5% of hydrogen, 19% of oxygen and 77.5% of nitrogen was circulated at a rate of 10400 standard l/h over the catalyst bed from the top downward by means of a gas compressor. The composition of the gas mixture was regulated as described in Example 1.

The product mixture leaving the reaction tube was separated from the gases while still under pressure in a separator and discharged from the plant in liquid form. The mass flow was balanced with the feed stream. The hydrogen peroxide content of the liquid output was determined by titration.

The amount of hydrogen consumed by the formation of hydrogen peroxide and water could be calculated from the mass flows of the gases introduced and from the flow of offgas. The selectivity based on hydrogen was calculated from the mass of the output stream, the hydrogen peroxide content and the amount of hydrogen consumed. The space-time yield was given by the amount of hydrogen peroxide formed per unit time divided by the volume of 700 ml of catalyst bed in the tube reactor.

After an operating time of 6 hours, a steady state had been established and this was maintained for 200 hours. 6.9% by weight of hydrogen peroxide and 0.9% by weight of water were measured in the liquid output stream. The selectivity based on hydrogen was 81% and the space-time yield based on the catalyst volume was 112 g/l*h.

We claim:

1. A process for the continuous preparation of a solution of hydrogen peroxide in a medium comprising a water-miscible organic solvent, in which
a) a catalyst comprising a noble metal is installed in a reaction zone;
b) a liquid stream comprising a water-miscible organic solvent is passed through the reaction zone;
c) a gas stream comprising hydrogen, oxygen and an inert gas, where the volume ratio of inert gas to oxygen is at least 2.5:1, is simultaneously passed through the reaction zone;
d) after passage through the reaction zone, the gas stream which has been depleted in hydrogen and oxygen is taken off and recirculated to the reaction zone;
e) the gas stream is admixed with essentially pure hydrogen and essentially pure oxygen; and
f) the hydrogen peroxide solution formed is taken off as a liquid stream.

2. A process as claimed in claim 1, wherein the catalyst comprising a noble metal comprises, as active component, palladium which may further comprise amounts of platinum, rhodium, iridium, ruthenium, gold, copper, cobalt, tungsten, molybdenum, tin, rhenium, phosphorus or boron.

3. A process as claimed in any of the preceding claims, wherein the organic solvent is an alcohol having from 1 to 4 carbon atoms, a ketone having from 3 to 5 carbon atoms, and alkanediol having from 2 to 4 carbon atoms, a dialkyl ether, an alkanediol monoalkyl ether having a total of from 3 to 8 carbon atoms, an alkanediol diethyl ether having a total of from 4 to 10 carbon atoms, or a cyclic ether having from 4 to 6 carbon atoms and 1 or 2 ring oxygens.

4. A process as claimed in claim 3, wherein the organic solvent is methanol, ethanol, n-propanol, isopropanol, acetone, butanone, methyl isopropyl ketone, ethylene glycol, propylene glycol, methyl glycol, ethyl glycol, butyl glycol, propylene glycol monomethyl ether, propylene glycol monoethyl ether, ethylene glycol diethyl ether, tetrahydrofuran or dioxane.

5. A process as claimed in any of the preceding claims, wherein the inert gas is nitrogen, carbon dioxide or a noble gas.

6. A process as claimed in any of the preceding claims, wherein the proportion of hydrogen in the gas phase does not exceed 4% by volume at any point in the reaction zone.

7. A process as claimed in any of the preceding claims, wherein the molar ratio of oxygen to hydrogen in the gas stream is from 2:1 to 100:1.

8. A process as claimed in any of the preceding claims, wherein the composition of the gas stream and/or the depleted gas stream is analyzed continuously or periodically, the composition is compared with a prescribed composition and hydrogen, oxygen and/or inert gas are added in amounts indicated by the comparison.

9. A process as claimed in any of the preceding claims, wherein the liquid stream comprises stabilizers.

10. A process as claimed in any of the preceding claims, wherein the hydrogen peroxide solution obtained is reacted with an olefin to give an epoxidized olefin.

11. A process as claimed in claim 10, wherein the used hydrogen peroxide solution is recirculated as a liquid stream to the reaction zone.
